(19) United States
(12) Patent Application Publication
(10) Pub. No.: US 2007/0224993 A1
(43) Pub. Date: Sep. 27, 2007

(54) Apparatus, method and computer program product providing unified reactive and proactive handovers

(75) Inventor: Dan Forsberg, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/729,135

(22) Filed: Mar. 27, 2007

Related U.S. Application Data
(60) Provisional application No. 60/786,600, filed on Mar. 27, 2006.

(51) Int. Cl. H04Q 7/20

(52) U.S. Cl. 455/436

(57) ABSTRACT

Apparatus, methods and computer program products incorporate improvements that provide enhanced security during handovers in a cellular wireless communications network. In one aspect, user equipment performs additional operations during handover to improve security. During such operations, user equipment begins key generation based on a predicted target base station before it is notified of the handover decision. User equipment also signs certain communications generated during handover operations to prevent hijacked base stations from generating false location updates. Separate keys are used to authenticate communications made by base stations during handover proceedings defeating, for example, logical theft of service attacks since a target base station's signature and encrypted content is required to be sent to the user equipment before the user equipment can switch to the target base station. In other aspects, user equipment assigns location updates sequence numbers and the active gateway keeps track of them defeating attacks based on replay of intercepted location update messages.

### CROSS REFERENCE TO A RELATED UNITED STATES PATENT APPLICATION

This application hereby claims priority under 35 U.S.C. §119(e) from copending provisional U.S. Patent Application No. 60/786,600 entitled “APPARATUS, METHOD AND COMPUTER PROGRAM PRODUCT PROVIDING UNIFIED REACTIVE AND PROACTIVE HANDOVERS” filed on Mar. 27, 2006 by Dan Forsberg. This preceding provisional application is hereby incorporated by reference in its entirety.

### TECHNICAL FIELD

The exemplary and non-limiting embodiments of this invention relate generally to wireless communications systems, methods, computer program products and devices and, more specifically, relate to hand over or hand off (HO) procedures executed when a user equipment (UE) changes cells.

### BACKGROUND

The following abbreviations are herewith defined:

| | |
|---|---|
| 3GPP | Third Generation Partnership Project |
| C Plane | control plane |
| CN | core network |
| DL | downlink (Node B to UE) |
| GW | gateway (aGW = active GW) |
| LTE | Long Term Evolution |
| MME | mobile management entity |
| Node B | base station |
| RNC | radio network control |
| RNTI | radio network temporary identity (C-RNTI = C plane RNTI) |
| RRC | radio resource control |
| SKC | secret key cryptography (aka as symmetric key cryptography) |
| UE | user equipment |
| UPE | user plane entity |
| UL | uplink (UE to Node B) |
| UMTS | Universal Mobile Telecommunications System |
| UTRAN | UMTS Terrestrial Radio Access Network |
| E-UTRAN | Evolved UTRAN |

An important aspect of a handover or handoff of a mobile communication device from a serving cell to a neighbor cell is security protection. This can be particularly important in view of the potential to use smaller and low-cost cell equipment as node-Bs (which may referred to as eNBs).

Some problems with previous proposals in this regard include the following:
reactive handover was considered an error case and was not integrated with the proactive handover;
message sizes were quite large, and it was possible to track UE movements because the signals were not properly encrypted;
key derivation occurred during the radio break, meaning that more resources were needed during the break; and
nonces were used quite liberally and inconsistently.

As employed herein a nonce is considered to be a random variable used as an input for a key negotiation process. Nonces provide key freshness, as they are selected separately for each key negotiation process.

Prior to this invention, no completely satisfactory solution has been proposed to overcome these and other problems.

### SUMMARY OF THE INVENTION

A first embodiment of the invention is user equipment comprising a transceiver configured for bidirectional communication in a wireless telecommunications network; and user equipment control apparatus. The user equipment control apparatus is configured to perform handoff-related measurements using the transceiver; to select at least one handoff candidate from available base stations in dependence on the handoff-related measurements; and to begin generation of at least one security key for use in communication with the at least one handoff candidate if the at least one handoff candidate is selected to receive the handoff, the security key generation beginning prior to receipt of a message by the user equipment identifying the base station selected by the network to receive the handoff.

A second embodiment of the invention is a base station comprising a transceiver configured for bidirectional communication in a wireless telecommunications network; and base station control apparatus. The base station control apparatus is configured to operate the base station as a source base station during handoff operations; and to add context identification information to handoff-related messages when operating as a source base station, the context identification information identifying a context for a handoff.

A third embodiment of the invention is a base station comprising at least a transceiver configured for bidirectional communication in a wireless telecommunications network and base station control apparatus. The base station control apparatus is configured to operate the base station as a source base station during handoff operations; to identify context identification information in handoff-related messages received from source base stations; to determine whether the base station has received context for a handoff using the context identification information; and if context for a handoff has not been received, to use the context identification information to request the context from a source base station.

A fourth embodiment of the invention is a method comprising: at user equipment in a wireless communication system: predicting a candidate base station to receive a handoff from a source base station currently handling communications for the user equipment; and pre-calculating at least one security key to be used for communicating with the candidate base station if the candidate base station receives the handoff.

A fifth embodiment of the invention is a computer program product comprising a computer readable memory medium storing a computer program. The computer program is configured to be executed by digital processing apparatus of user equipment operative in a wireless telecommunications network. When the computer program is executed operations are performed. The operations comprise: predicting a candidate base station to receive a handoff from a source base station currently handling communications for the user equipment; and pre-calculating at least one security key to be used for communicating with the candidate base station if the candidate base station receives the handoff.

A sixth embodiment of the invention is an integrated circuit for use in a base station operative in a wireless communications network. The integrated circuit comprises circuitry configured to operate the base station as a source base station during handoff-related operations; to access a measurement report message received by the base station from user equipment; to select, in dependence on data contained in the measurement report message, a target base station to receive a handoff involving the user equipment; to generate a context data message containing at least context identification information for the handoff; to encrypt at least the context identification information portion of the context data message with a user-equipment-specific security key shared by the source and target base station; and to cause the base station to transmit the context data message to the target base station.

In conclusion, the foregoing summary of the alternate embodiments of the invention is exemplary and non-limiting. For example, one of ordinary skill in the art will understand that one or more aspects from one embodiment can be combined with one or more aspects from another embodiment to create a new embodiment within the scope of the present invention. In addition, one skilled in the art will understand that operations in accordance with the invention performed in embodiments expressed as methods can also be performed by apparatus. Such apparatus is also within the scope of the invention.

### BRIEF DESCRIPTION OF THE DRAWINGS

In the attached Drawing Figures:

FIG. 1 shows a simplified block diagram of various electronic devices that are suitable for use in practicing the exemplary embodiments of this invention;

FIG. 2 shows the relative orientation of FIG. 2A to FIG. 2B, which together depict a first exemplary embodiment of an inter-radio access handoff security as example of the utility of the exemplary embodiments of this invention. FIGS. 2A and 2B are connected via the circular connectors designated as A, B, C and D;

FIG. 3 shows the relative orientation of FIG. 3A to FIG. 3B, which together depict a second exemplary embodiment of an inter-radio access handoff security as a further example of the utility of the exemplary embodiments of this invention. FIGS. 3A and 3B are also connected via the circular connectors designated as A, B, C and D;

FIG. 4 is a flowchart depicting a method performed by user equipment during an HO implemented in accordance with an exemplary embodiment of the invention;

FIG. 5 is a flowchart depicting a method performed by a target base station during an HO implemented in accordance with an exemplary embodiment of the invention;

FIG. 6 is a flowchart depicting a method performed by user equipment during an HO implemented in accordance with an exemplary embodiment of the invention; and

FIG. 7 is a flowchart depicting a method performed by user equipment during an HO implemented in accordance with an exemplary embodiment of the invention.

### DETAILED DESCRIPTION

By way of introduction, RRC termination on an eNB, and an interface between eNBs have been previously agreed upon (see 3GPP Technical Report, TR25.912, incorporated by reference herein). One aspect of this is “common UE specific keys” working assumptions for eNBs. Reference may also be made to a S3-060033 contribution for SA3#42, Bangalore (incorporated by reference herein) which presents some security measures for an intra-eNB handover procedure.

### Security Measures

Security measures have been considered to mitigate denial of service (DoS) and resource theft attacks that an attacker may create by hijacking an eNB and/or injecting packets (threats such as man-in-the-middle and false-eNB. Reference in this regard can be made to S3-060034, Discussion of threats against eNB and last-mile in Long Term Evolved RAN/3GPP System Architecture Evolution (incorporated by reference herein in its entirety)).

In accordance with exemplary embodiments of this invention, the UE is enabled to guess or predict which base station would be the best HO candidate based on measurements, and the UE can begin key generation before the network transmits a message containing the HO decision. The exemplary embodiments of this invention also unify reactive and proactive handovers by adding context id into proper messages, making it possible for the target eNB to detect if it has already received the context. If the target eNB has not yet received the context it can request it from the source eNB with the context id. This procedure thus unifies reactive and proactive handovers. The exemplary embodiments of this invention also provide for adding a new message after a “HO Confirm” message from the target eNB to the UE. The message contains the context id for the target eNB UE context, and a new network nonce to be used in the next handover and key derivation.

As will be discussed in greater detail below, the use of the exemplary embodiments of this invention provides for improved performance and simpler error recovery if the UE loses the connection to the serving base station, especially during HO; a unification of reactive and proactive HOs; and also enhanced security.

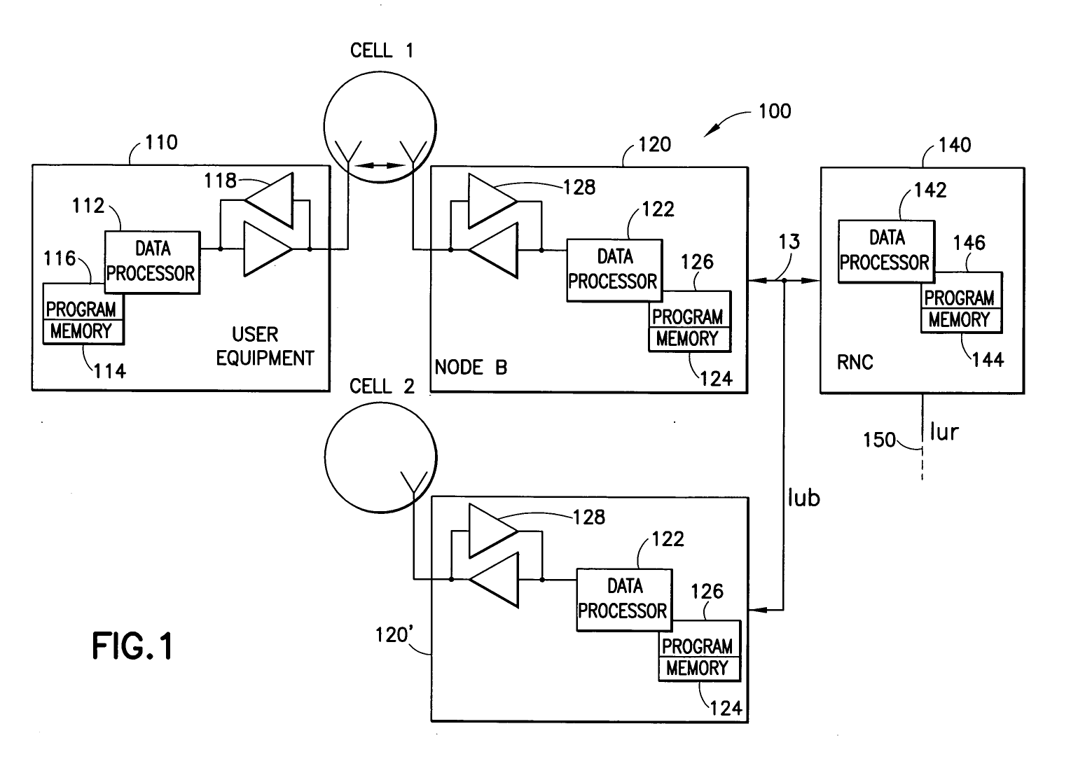

Reference is made first to FIG. 1 for illustrating a simplified block diagram of various electronic devices that are suitable for use in practicing the exemplary embodiments of this invention. In FIG. 1 a wireless network 100 is adapted for communication with a UE 110 via a node B (base station) 120. The network 100 may include an RNC 140, or other radio controller function, which may be referred to as a serving RNC (SRNC). The UE 110 includes a data processor 112, a memory 114 that stores a program 116, and a suitable radio frequency transceiver 118 for bidirectional wireless communications with the node B 120, which also includes a data processor 122, a memory 124 that stores a program 126, and a suitable RF transceiver 128. The node B 120 is coupled via a data path 130 (Iub) to the RNC 140 that also includes a data processor 142 and a memory 144 storing an associated program 146. The RNC 140 may be coupled to another RNC (not shown) by another data path 150 (Iur). At least one of the programs 116, 126 and 146 is assumed to include program instructions that, when executed by the associated data processor, enable the electronic device to operate in accordance with the exemplary embodiments of this invention, as will be discussed below in greater detail.

Shown in FIG. 1 is also a second node B 120′, it being assumed that the first node B 120 establishes a first cell (Cell 1) and the second node B 120′ establishes a second cell (Cell 2), and that the UE 110 is capable of a handoff from one cell to another. In FIG. 1 the Cell 1 may be assumed to be a currently serving cell, while Cell 2 may be a neighbor or target cell to which handoff may occur. Note that the node Bs could be coupled to the same RNC 140 (as shown), or to different RNCs 140. Note that while shown spatially separated, Cell 1 and Cell 2 will typically be adjacent and/or overlapping, and other cells will typically be present as well.

The node Bs 120 may also be referred to for convenience as a serving eNB and as a target eNB.

The exemplary embodiments of this invention may be implemented by computer software executable by the data processor 112 of the UE 110 and the other data processors, such as in cooperation with a data processor in the network, or by hardware, or by a combination of software and/or firmware and hardware.

In general, the various embodiments of the UE 110 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memories 114, 124 and 144 may be of any type suitable to the local technical environment and may be implemented using any suitable data storage technology, such as semiconductor-based memory devices, magnetic memory devices and systems, optical memory devices and systems, fixed memory and removable memory. The data processors 112, 122 and 142 may be of any type suitable to the local technical environment, and may include one or more of general purpose computers, special purpose computers, microprocessors, digital signal processors (DSPs) and processors based on a multi-core processor architecture, as non-limiting examples.

Having thus introduced one suitable but non-limiting technical context for the practice of the exemplary embodiments of this invention, the exemplary embodiments will now be described with greater specificity.

Describing now the exemplary embodiments of this invention in greater detail, in order to achieve the benefits and advantages discussed above, it is assumed that any eNB shall not be able to launch denial of service attacks towards other eNBs, MMEs, or UPEs with handoff signaling messages to mitigate the threat of a hijacked eNB. To fulfill this goal UE-specific separate keys for each eNB are employed. It is also assumed that the UE must sign path switch messages towards an aGW, and that it is preferred to use RRC ciphering, in addition to integrity protection, except for some message parts in the first message from UE to the target eNB in the handover.

It is also assumed that there are no separately managed security associations between eNBs. Also, a desired goal is to assume minimal trust between eNBs, which is consistent with the assumption of the presence of small and low cost eNBs, for example in home and office environments.

It is also preferred to employ SKC based eNB-eNB signaling security protection.

It is noted that a non-limiting assumption is to reuse UMTS security algorithms for key derivation (CK, IK), encryption and, as an example, for integrity protection for the RRC signaling. However, one may assume that the 128 bit RAND used in UMTS (see 3GPP TS 33.102 v3.5.0: “3rd Generation Partnership Project; Technical Specification Group Services and System Aspects; 3G Security; Security Architecture”, incorporated by reference herein) is created from 64 bit nonces from UE (Nonce_{UE}) and from the network (Nonce_{NET}) with concatenation (Nonce_{UE}∥Nonce_{NET}). The FRESH value is derived from the nonces if required in LTE. However, the size of the nonce may be an issue when sent in the measurement report message, and thus may not be used in every case.

### Security Analysis

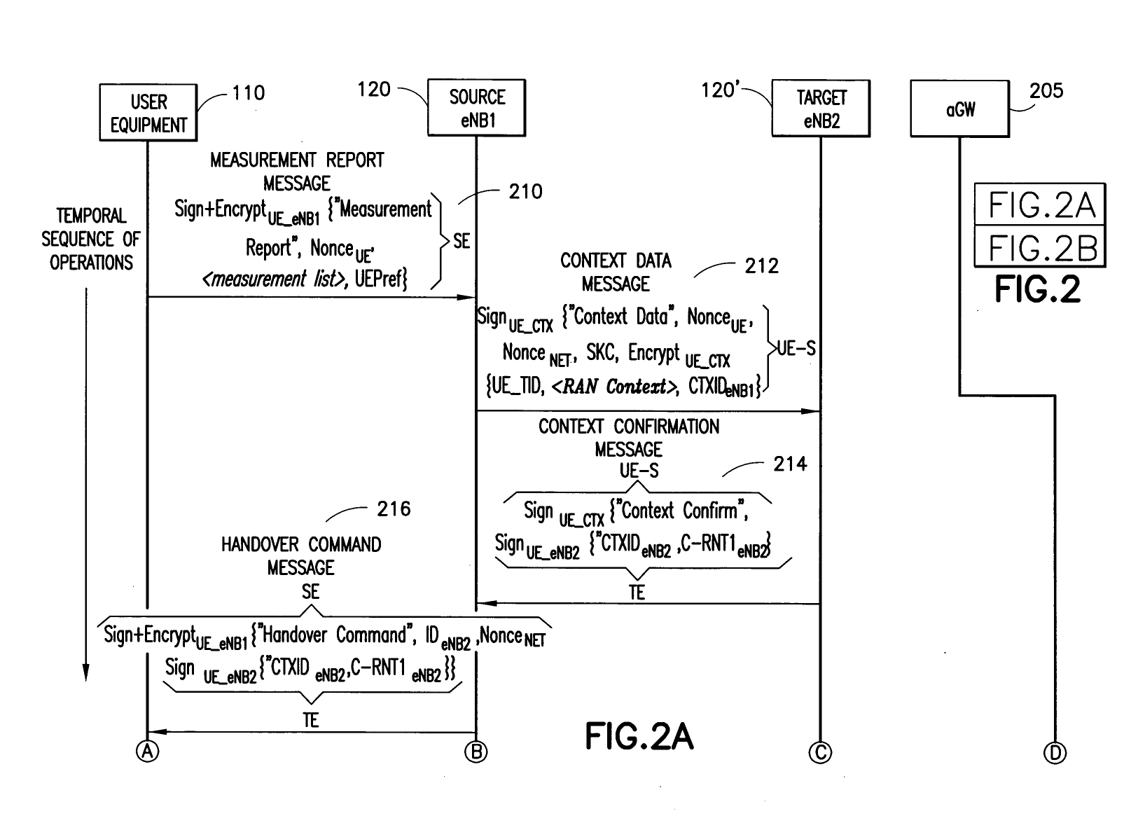

Based on the security measures of the exemplary signaling flow shown in FIG. 2, and discussed in further detail below, one may conclude the following.

A. UE 110 signature for path switch: An (hijacked) eNB cannot spoof location updates to the MME/UPE since the UE's signature is required in the message. Also, an attacker cannot inject location update messages to the MME/UPE, because the message is signed. A case, where an eNB would start to signal path switch update messages to the core network on behalf of multiple UEs, and without UE signatures, is not acceptable and poses a high risk if not mitigated.

B. UE 110 signature for path switch: An (hijacked) eNB can not replay the location update messages to the MME/UPE, since the aGW keeps track of the received Sequence numbers (and if the UE_TID (Transaction Identifier) is changed).

C. Separate keys: An (hijacked) eNB cannot launch denial of service attacks against other eNBs, MMEs, or UPEs, because the UE's signature and sequence number are required in the messages.

D. Separate keys: An (hijacked) eNB cannot perform a logical service theft for the UE 110 by commanding it to another eNB, because the target eNB's signature and encrypted content is required to be sent to the UE 110, before the UE 110 can switch the radio to the target eNB.

E. Separate keys: Man-in-the-middle eNB condition is not possible, as the SK key derivation is bound to the eNB identity, and the MME encrypts the SK key for the eNBs (i.e., it is not created based on the over-the-air signaling). Thus, the eNB is also authenticated for the UE 110.

F. Separate keys: An attacker cannot send spoofed (or replay) measurement reports on behalf of the UE 110, since the UE 110 signs them.

G. RRC ciphering: An eavesdropper cannot bind together the old and new C-RNTIs, because they are not sent in plain text in a single packet. An attacker hijacking the eNB may possibly perform this mapping, but only for the two C-RNTIs that it can see, not the entire chain of them (i.e. the C-RNTI is changed in every handoff). Also, since the handoff messages are mostly encrypted, the binding between them is not possible to readily ascertain without accurate timing analysis and making distinction between possible other handoffs.

H. RRC ciphering: An eavesdropper cannot obtain the location of the UE 110 by examining the measurement reports, since they are encrypted. Also, an attacker cannot spoof measurement reports. Note that a malicious UE 110 may attack the network by sending different bogus measurement reports to the serving eNB, and not actually by performing the handoff. This is not a serious threat, as the serving eNB can readily detect this type of aberrant UE behavior.

I. UE-specific eNB-eNB security: With the SPK key within the SKC entry for each eNB, the target-eNB is only able to decrypt the received context, as the other SKC entries are encrypted with the SPK key and thus other eNBs cannot obtain the UE-specific SKC entry if it is not explicitly sent to them.

J. UE-specific eNB-eNB security: With SPKs shared within the SKC, there is no need to pre-establish shared keys between eNBs. This allows the establishment of a secure mesh network between the eNBs listed in the SKC.

Based on the foregoing, it can be appreciated that exemplary aspects of this invention are directed to providing enhanced security measures for an eNB-to-eNB handoff in LTE_ACTIVE mode. It is shown that the resulting system with eNB-to-eNB handoff signaling is secure and does not allow a single node (eNB, UE) to launch logical denial of service or resource theft attacks based on handoff signaling. A desirable aspect of the exemplary embodiments of this invention is in providing separate UE-specific session keys for each eNB, and a further desirable aspect is in requiring the presence of a UE signature for those path switching messages that are directed towards the core network.

It should be noted that the security measures discussed herein are not solely specific to the eNB-to-eNB interface, and that their use provides enhanced denial of service and theft of resources attack resistance for the entire network.

Discussed now with reference to FIGS. 2A and 2B, collectively referred to as FIG. 2, is a first non-limiting example of handoff signaling security measures in accordance with the foregoing description of the exemplary embodiments of this invention.

FIG. 2 presents the handoff signaling flow with added security measures in accordance with the exemplary embodiments of this invention. The following designations indicate which keys are used to sign/encrypt the messages:

content marked as “SE” is signed with the source-eNB keys;

content marked with “TE” is signed with the target-eNB keys; and

content marked with “CN” is signed with the CN keys (aGW 205).

In addition, “UE-S” denotes signatures/ciphering with a UE specific key that is shared securely through the SKC among the eNBs listed in the SKC. Reference in this regard may be had to S3-050721, Nokia Security Solution, SAE Security, Nokia contribution to SA3 meeting #41, San Diego, USA, Nov. 15-18, 2005 (incorporated by reference herein).

The following notation is used to show which contents are signed and/or encrypted:

Sign_{SK}{<content>};

Encrypt_{SK}{<content>}; and

Sign+Encrypt_{SK}{<content>}.

With this notation, an example row for an eNB in the SKC would appear as follows:

Sign_{eNB1}{ID_{eNB1}, Encrypt_{eNB1}{SK_{UE}_{_{—}}_{eNB1}, SPK_{UE}}}.

Here the key SK_{UE}_{_{—}}_{eNB1} between the UE 110 and eNB1, and the key SPK_{UE}, (the same in all the SKC rows for the same UE 110) are encrypted with a key shared between the eNB and the core network (Encrypt_{eNB1}). These encrypted keys and the eNB identification ID_{eNB1} is then signed together with the same key so that the receiving eNB can authenticate and verify the integrity of the SKC row.

The source for the key used for signing (IK) and/or encryption (CK) is presented with the “SK” notion, and the integrity protected and/or encrypted content (<content>) is inside the curly brackets ({}). Note that the signing and encryption procedures can be applied over the same or partially same content multiple times (overlapping signatures). IK and CK may be derived from the SK and RAND as in UMTS.

A reason for having only integrity protection for most of the messages is, for example, that the contents of the message can be used before the signature is verified (e.g., to derive IK based on the content and then verify the signature based on the derived IK), and also to check that the content is correct before forwarding the message. This allows error detection and tracing in early phases. However, if the signaling messages are not ciphered, they can be more easily mapped together in a handoff situation.

Referring now to the numbered messages in FIG. 2, the description of each is as follows.

1. UE 110 generates and signs and encrypts a measurement report message 210 that is transmitted to source base station eNB1 120. The eNB1 120 to which UE 110 is attached derives a handover decision to a new (target) Cell located at a target eNB2 120′ based on, e.g., the signed measurement report(s) 210 received from UE 110. With measurement report 210 UE 110 provides a fresh nonce (Nonce_{UE}) for the serving-eNB 120 if it has not been sent before. This nonce has not previously been used to create keys.

The temporal sequence of operations is shown in FIG. 2. An aspect of the invention concerning proactive preparation for handoffs is practiced at this stage prior to occurrence of the handoff. Using algorithms known to those skilled in the art UE 110 can calculate with a high degree of probability whether handoff will occur, and to which target eNB2 120′ handoff will be made. Thus it can pre-calculate keys if necessary before a handover command message is received from the serving base station eNB 1 120. UE 110 additionally can calculate keys for other eNB2s that may be selected to receive the handoff. The handoff decision is made by the network based, at least in part, on a load balancing criterion. Thus, UE 110 typically is not sure exactly which target base station eNB2 120′ will receive the handoff.

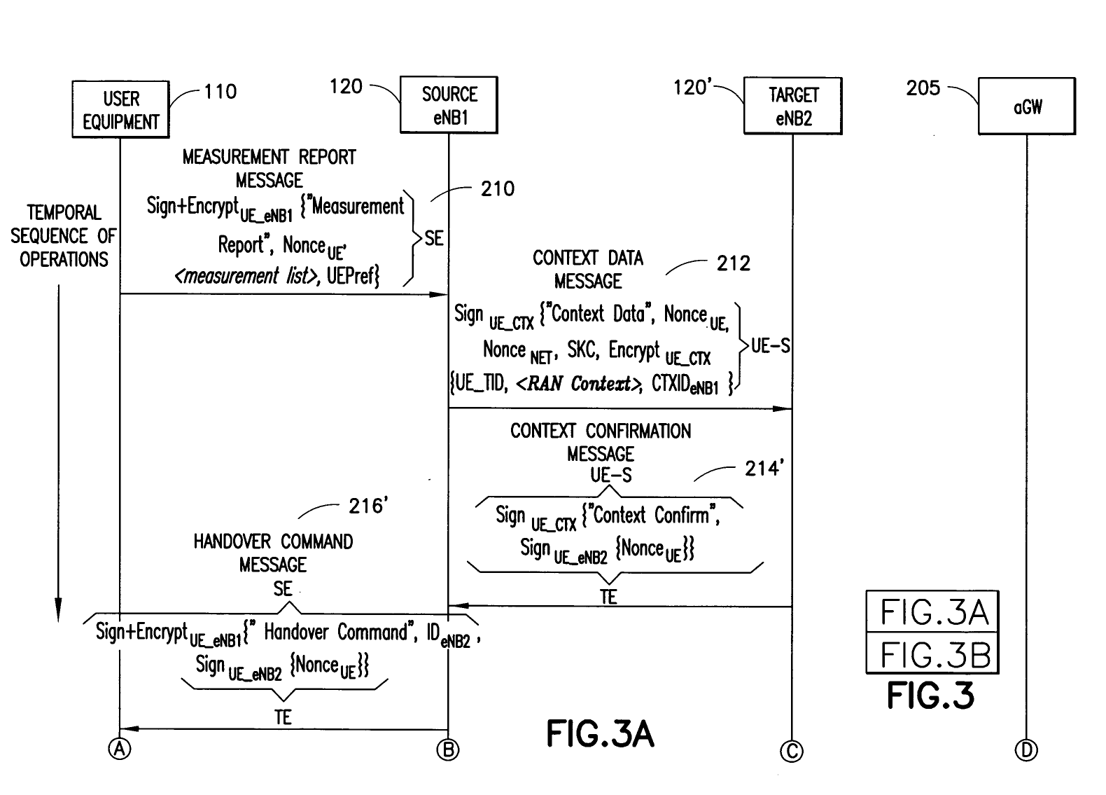

FIG. 4 depicts operations typically performed by UE 110 when pre-calculating keys to be used for communicating with the target eNB2 that is predicted to receive the handoff. At 410, UE 110 derives SK_{UE}_{_{—}}_{eNB2} based on a Root Key from the core network and the identity (ID_{eNB2}) of the predicted target base station eNB2 120′. Next, at 420, UE 110 derives encryption key CK_{UE}_{_{—}}_{eNB2} and signing key IK_{UE}_{_{—}}_{eNB2} based on SK_{UE}_{_{—}}_{eNB2}, Source base station eNB1 120 identity (ID_{eNB1}), Nonce_{UE}, Nonce_{NET}, and UE_TID.

2. When source eNB1 120 receives the measurement report message” 210 it decides whether to initiate a handoff procedure for UE 110. If it decides to initiate a handoff, source base station eNB2 120 generates a context data message 212 including at least UE-specific session keys context (SKC) (see again S3-050721, Nokia Security Solution, SAE Security, Nokia contribution to SA3 meeting #41, San Diego, USA, Nov. 15-18, 2005); the received Nonce_{UE} from UE 110; a Nonce_{NET}; and the UE_TID, along with other RAN context information. UE_TID and RAN context information are encrypted, to protect against eavesdroppers between the source and target eNBs, with a UE-specific SKC Protection Key (SPK_{UE}) that is shared among the eNBs listed in the UE's SKC (e.g., each of the rows in the SKC contains the SPK_{UE} encrypted for the specific eNB).

Note in this regard that this message does not have a signature from the UE 110. Thus, the target-eNB 120′ does not know if UE 110 is actually coming to target eNB 120′ with a completed handoff sequence. This allows pre-distribution of the SKC rows to neighboring eNBs. Further, this allows the serving-eNB to prepare multiple target-eNBs for the UE 110 and may thus reduce the handoff preparation time.

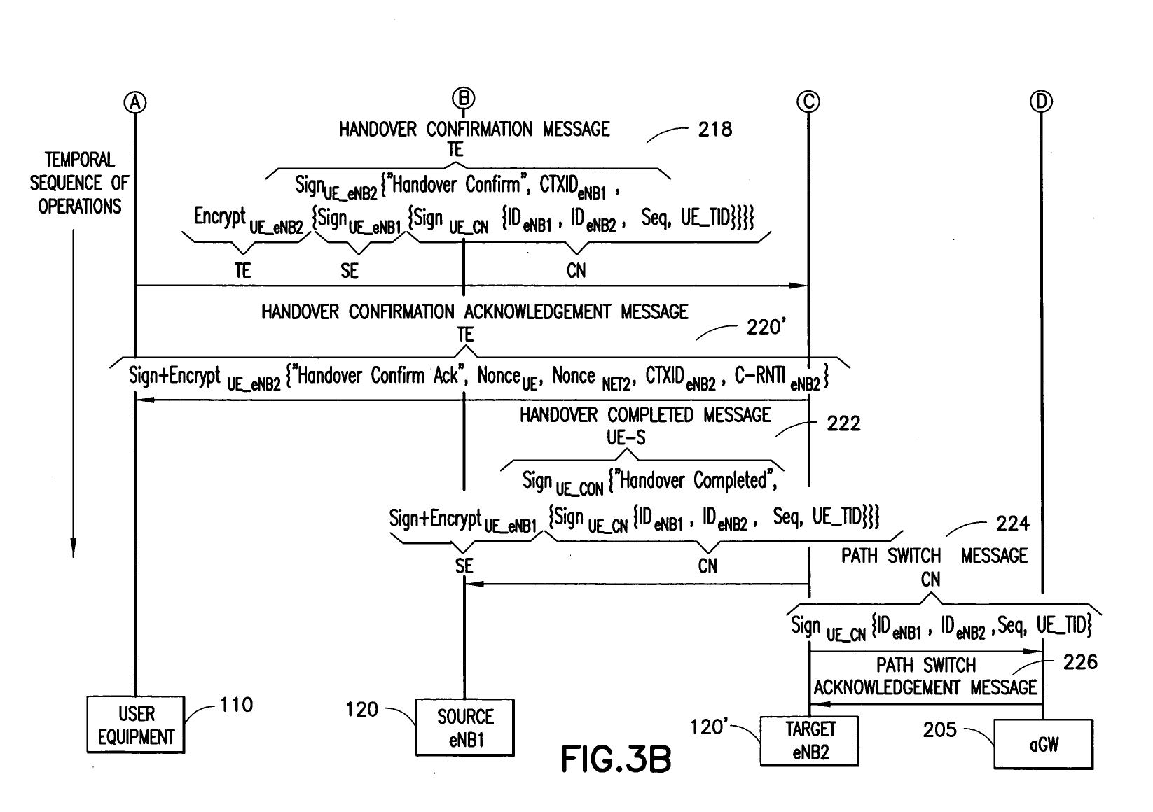

3. When target eNB2 120′ receives the context data message 212 it performs the operations depicted in FIG. 5. At 510, target eNB2 120′ checks whether the message was targeted to it (ID_{eNB2}). This prevents the packet from being replayed by an attacker for multiple eNBs. Then, at 520, target eNB2 120′ finds and verifies the row from the SKC created for the target eNB2 initially in the CN. It can be noted that even if the attacker would be able to replay this message, the attacker cannot modify the valid SKC entries. The target eNB2 also decrypts the SKC entry and retrieves SPK_{UE} from the SKC entry. Next, at 530, eNB2 120′ derives CK_{UE}_{_{—}}_{CTX} and IK_{UE}_{_{—}}_{CTX} from SPK_{UE}, and verifies the integrity protection of the Context Data Message 212. At 540, eNB2 120′ decrypts the UE_TID, nonces, and the RAN context. Then, at 550, based on the SK_{UE}_{_{—}}_{eNB2} in the SKC row for the target eNB2, nonces, and the UE_{‘3}TID, the target eNB2 derives CK_{UE}_{_{—}}_{eNB2} and IK_{UE}_{_{—}}_{eNB2} for the UE 10. With the CK_{UE}_{_{—}}_{eNB2} the target eNB2 at 560 encrypts Radio Link ID (C-RNTI_{eNB2}), Context ID (CTXID_{eNB2}), and UE_TID. The encrypted content is signed (with IK_{UE}_{_{—}}_{eNB2}) with eNB2 id (ID_{eNB2}), and the nonces.

It is noted that upon receipt of the context data message 212 target base station eNB2 120′ is ready to receive UE 110 in case of a reactive handoff, for example because UE 110 looses connection to the source base station eNB1 120.

The target eNB2 120′ then generates and transmits a context confirmation message 214, where the signed and encrypted contents are included. The message is signed with the IK_{UE}_{_{—}}_{CTX} key derived from SPK_{UE}.

4. When the source eNB1 120 receives context confirmation message 214 it forwards the content in a handover command message 216 to UE 110. The entire message is signed with IK_{UE}_{_{—}}_{eNB1}.

If a different target base station eNB2 120′ is selected to receive the handoff from that predicted by UE 110, UE 110 derives new keys using the method depicted in FIG. 4.

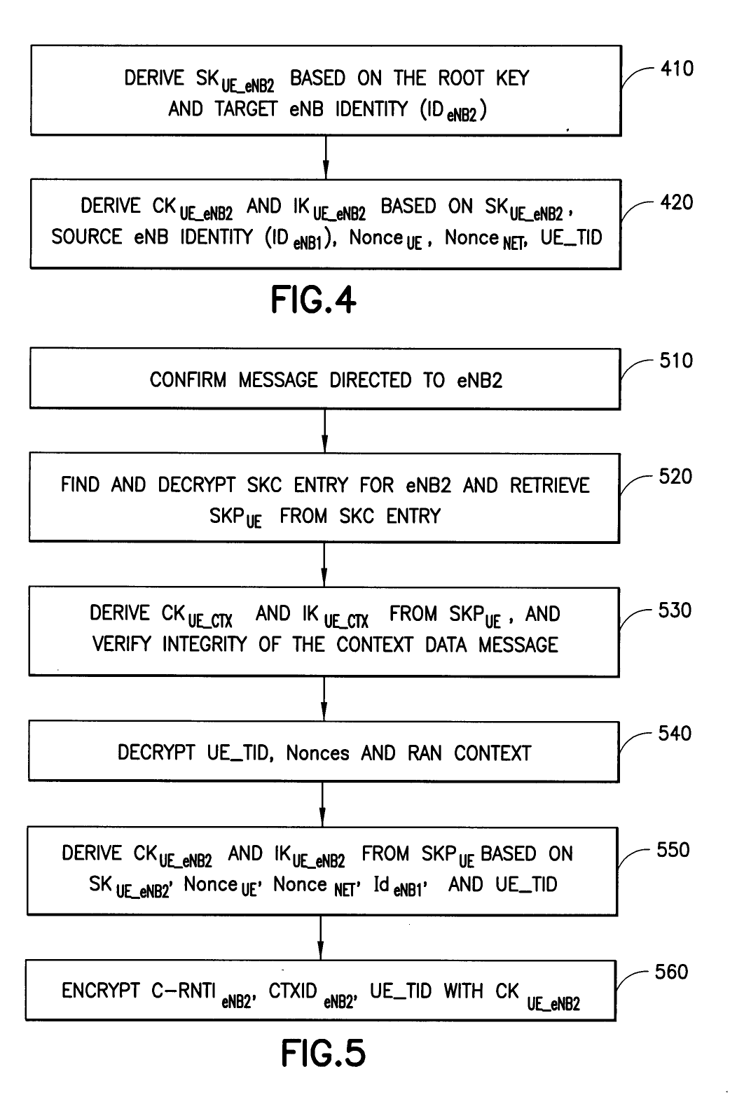

5. When UE 110 receives the handover command message 216 it performs the operations depicted in FIG. 6. At 610, UE 110 verifies the signature from eNB1 (RRC integrity protection). Then, at 620, UE 110 derives the IK_{UE}_{_{—}}_{eNB2} and CK_{UE}_{_{—}}_{eNB2} for eNB2 based on the Nonce_{UE}, Nonce_{NET}, Root Key, ID_{eNB2}, ID_{eNB1}, and UE_TID. With these keys UE 110 at 630 verifies the signature from target eNB2 and decrypts the C-RNTI_{eNB2} and CTXID_{eNB2}.

Note that UE 110 cannot derive the target eNB2 keys before it receives the nonces and the target eNB2 identity. If it is desired to begin this key derivation process earlier the nonce exchange can be performed earlier (for example in the last handoff signaling or in the beginning of the handoff signaling by adding an additional round trip between the UE 110 and the source eNB).

UE 110 then completes the handoff to target base station eNB2 120′ by sending a signed and partially encrypted handover confirmation message 218 to target base station eNB2 120′ (which will become the new source base station). This message contains signed content created with keys that UE 110 and the aGW share (IK_{UE}_{_{—}}_{CN}, CK_{UE}_{_{—}}_{CN}). This signed content is used as verification by the aGW 205 in path switch message 224 (described below). The Seq number is provided for replay protection. The message is also signed for the eNB1 to ensure that the source eNB1 is able to check that the UE 110 was successfully connected to the target eNB2 (handover completed message 222, described below). Encryption protects against UE_TID based location tracking (see R3-060035, Security of RAN signaling, Nokia contribution to the joint RAN2/3-SA3 meeting #50, Sophia-Antipolis, France, Jan. 9-13, 2006, incorporated by reference herein).

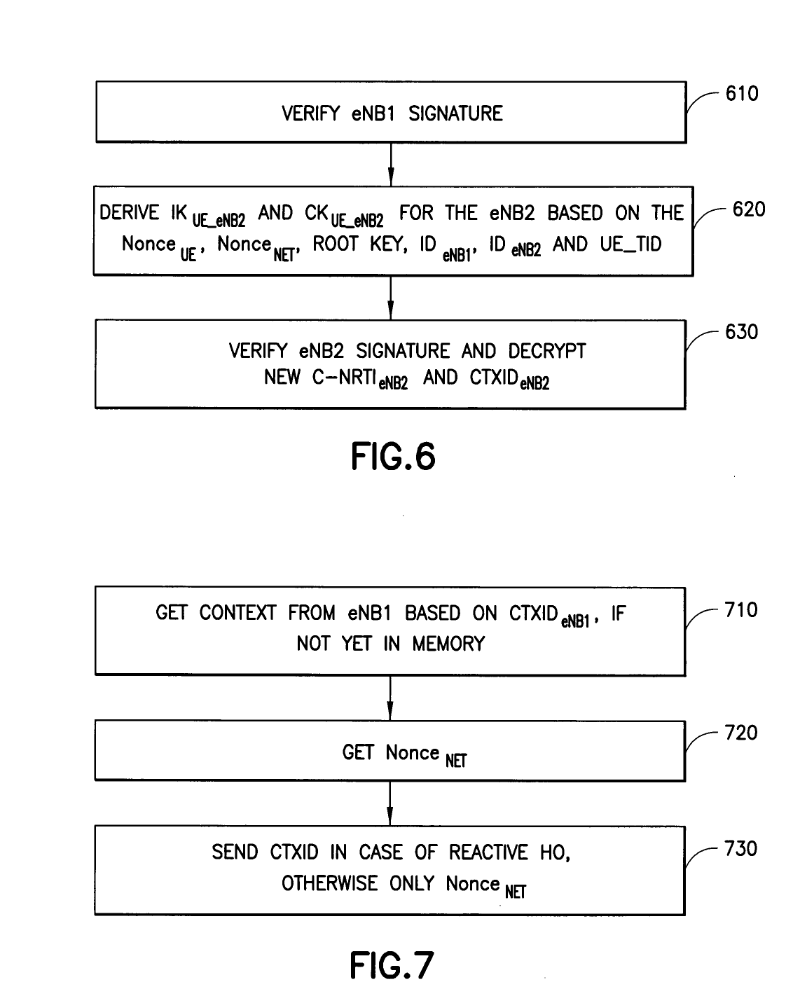

6. Target base station eNB2 120′ receives the handover confirmation message 218 and performs the steps depicted in FIG. 7. At 710, eNB2 120′ gets context from eNB1 based on CTXID_{eNB1} if not yet in memory. Then, at 720 eNB2 120′ gets a new Nonce_{NET}. Next, at 730, eNB2 120′ replies to handover confirmation message 218 with a handover confirmation acknowledgement message” 220; this contains a new NonceNET and optionally CTXID_{eNB2} in the case of a reactive HO.

Upon receipt of the handover confirmation acknowledgement message 220, UE 110 stores the new Nonce_{NET} and creates a new Nonce_{UE}.

7. When target base station eNB2 120′ receives the handover confirmation message 218, it also forwards it with signature to the source eNB1 in the handover completed message 222. Source eNB1 120 is then able to verify that the message contains correct eNB identities (i.e., source and target) and that it came from the UE 110 (signature and encryption with the key between UE and source eNB1). The original source base station eNB1 120 releases UE context if necessary at this point.

8. Target base station eNB2 120′ then sends a signed path switch message 224 to the aGW 205. This message contains the contents from the handover confirmation message 218 that UE 110 signed for the CN. The UE_TID is also included.

9. The aGW sends a path switch acknowledgment message 226 to the target eNB2.

As is apparent from FIG. 2 key derivation is here bound to source eNB1 120, which makes it unnecessary to transfer IDs and Nonces over the air in the handover command message 216. Replay protection is implemented by using integrity-protected sequence numbers. CTXID for reactive handoff is for the source base station eNB1 120 so that the proper context can be found since UE 110 cannot encrypt the UE_TID (otherwise the source base station 120 would not be able to find the proper decryption key). CTXID is sent to target eNB2 120′ in case of a reactive handoff. Target base station eNB2 120′ finds the context based on the CTXID if it has been distributed to it.

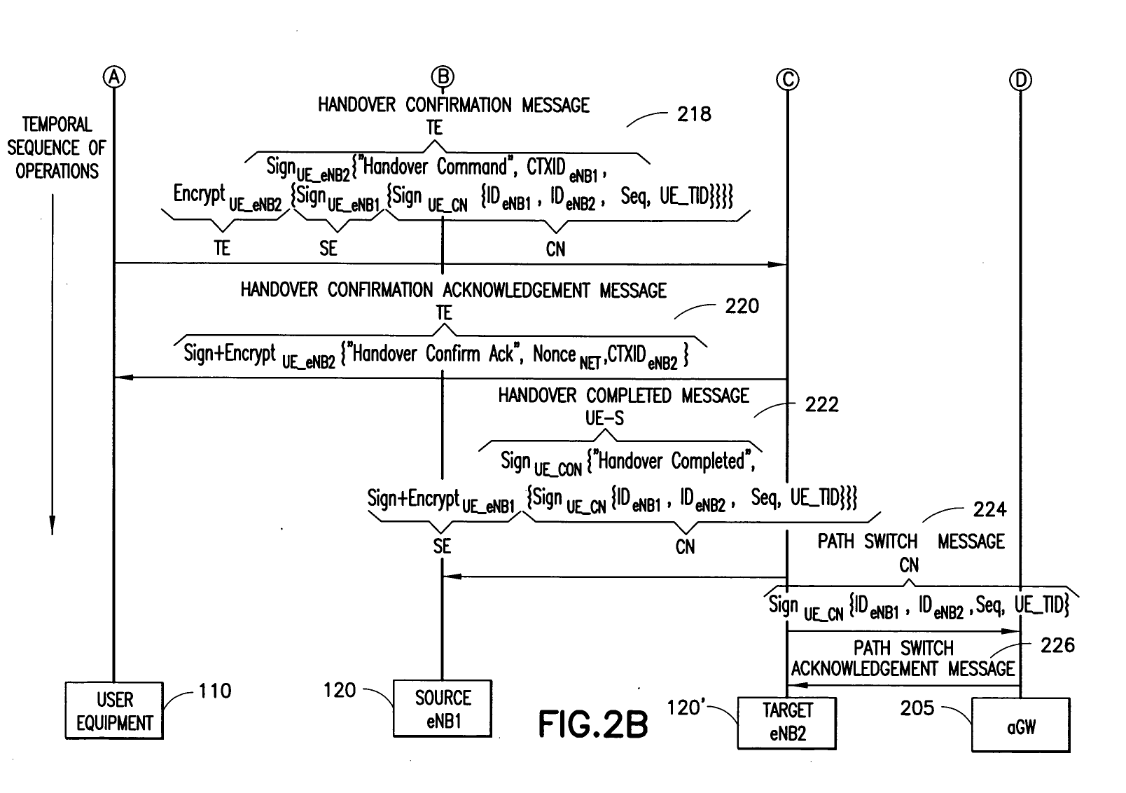

Reference is now made to FIG. 3 for illustrating a second exemplary embodiment of an inter-radio access handoff security as a further example of the utility of the exemplary embodiments of this invention. FIG. 3 differs from FIG. 2 in the messages 214′, 216′ and 220′ and more specifically differs in transferring the CTXID, C-RNTI and the Nonce(s) in message 220′, as opposed to the messages 216′ and 220′. In other respects the description of FIG. 2 is herewith incorporated into the description of FIG. 3.

Based on the foregoing, it should be apparent that in accordance with the exemplary embodiments of this invention there are provided methods, apparatus and computer program products for enabling multiple involved nodes to sign messages and use cryptographically separate UE-specific keys for eNBs to thereby facilitate secure handoff procedures and to provide improved performance and simpler error recovery if the UE 10 loses the connection to the serving eNB, especially during handoff, as well as to provide a unification of reactive and proactive handoffs and enhanced security.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams and message flow diagrams, it should be understood that these blocks, apparatus, systems, techniques or methods described herein may be implemented in, as non-limiting examples, hardware, software, firmware, special purpose circuits or logic, general purpose hardware or controller or other computing devices, or some combination thereof.

One of ordinary skill in the art will understand that computer programs capable of performing methods depicted and described herein can be embodied in a tangible computer-readable storage medium. Such a suitably programmed computer-readable storage medium thus comprises another embodiment of the invention. Instructions of the computer programs embodied in the tangible computer-readable memory medium perform the steps of the methods when executed. Tangible computer-readable memory media include, but are not limited to, hard drives, CD- or DVD ROM, flash memory storage devices or in RAM memory of a computer system.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

For example, FIGS. 2 and 3 illustrate two exemplary approaches to the message flow between the UE 10, the eNBs and the aGW, and it is thus possible that those skilled in the art may derive other modifications to the message flow. However, all such and other modifications will still fall within scope of the exemplary embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A user equipment comprising:
a transceiver configured for bidirectional communication in a wireless telecommunications network; and
user equipment control apparatus configured to perform handoff-related measurements using the transceiver; to select at least one handoff candidate from available base stations in dependence on the handoff-related measurements; and to begin generation of at least one security key for use in communication with the at least one handoff candidate if the at least one handoff candidate is selected to receive the handoff, the security key generation beginning prior to receipt of a message by the user equipment identifying the base station selected by the network to receive the handoff.

2. The user equipment of claim 1 wherein the at least one handoff candidate is different from the base station selected by the network to receive the handoff.

3. The user equipment of claim 2 wherein the user equipment is further configured to generate a different security key for use in communications with the base station selected by the network to receive the handoff.

4. The user equipment of claim 1 wherein the user equipment control apparatus is further configured to generate a measurement report; and to cause the transceiver to transmit the measurement report to a source base station.

5. The user equipment of claim 4 wherein the user equipment control apparatus is further configured to include information identifying the handoff candidate in the measurement report.

6. The user equipment of claim 4 wherein the user equipment control apparatus is further configured to receive a nonce and to include the nonce in the measurement report.

7. The user equipment of claim 4 wherein the user equipment control apparatus is further configured to sign and encrypt the measurement report with a session-specific security key shared only with the source base station.

8. The user equipment of claim 1 wherein when generating at least one security key the user equipment control apparatus is further configured to derive a secret key based on a root key and identity of the at least one handoff candidate.

9. The user equipment of claim 8 wherein the user equipment control apparatus is further configured to derive keys to be used to sign and to encrypt communications, wherein the keys for signing and for encryption are derived from the secret key for use in communicating with the handoff candidate; identity of the source base station; a nonce generated by the user equipment; a nonce generated by the network; and a temporary identification assigned to the user equipment.

10. The user equipment of claim 4 wherein the user equipment control apparatus is further configured to access a handover command message received by the transceiver from a source base station, wherein the handover command message identifies a target base station to which the handoff will be made.

11. The user equipment of claim 10 wherein the user equipment control apparatus is further configured to verify a source base station signature used to sign the handover command message.

12. The user equipment of claim 10 where the handover command message is signed and encrypted with a session-specific security key shared only between the user equipment and the source base station, and wherein the user equipment control apparatus is further configured to verify and decrypt the handover command message with the session specific security key.

13. The user equipment of claim 10 wherein the handover command message comprises content generated by the target base station to which the handoff will be made, the content generated by the target base station signed by the target base station with a session—specific security key shared only between the user equipment and the target base station.

14. The user equipment of claim 13 where the signed content comprises anew C-RNTI and CTXID, and wherein the user equipment control apparatus is further configured to verify the content with the key shared with the target base station.

15. The user equipment as in claim 13 wherein the user equipment control apparatus is further configured to determine whether the content contained in the handover command message generated by the target base station is signed with the correct security key and to complete the handoff only if it is determined that the content generated by the target base station is signed with the correct security key.

16. The user equipment of claim 10 wherein the user equipment is further configured to generate a handover confirmation message containing a sequence number to be used by the wireless telecommunications network to track location update messages; and to cause the transceiver to transmit the handover confirmation message to the target base station selected to receive the handoff.

17. The user equipment of 10 wherein the user equipment is further configured to generate a handover confirmation message containing content signed with a security key shared only between the wireless telecommunications network and the user equipment, and to cause the transceiver to transmit the handover confirmation message to the target base station selected to receive the handoff.

18. A base station comprising:
a transceiver configured for bidirectional communication in a wireless telecommunications network; and
base station control apparatus configured to operate the base station as a source base station during handoff operations; and to add context identification information to handoff-related messages when operating as a source base station, the context identification information identifying a context for a handoff involving a user equipment.

19. The base station of claim 18 wherein the base station control apparatus is further configured to access a measurement report message received by the transceiver from the user equipment; and to select a target base station to receive a handoff based on the measurement report.

20. The base station of claim 19 where the measurement report message is signed and encrypted with a session-specific security key shared only between the user equipment and the source base station, and wherein the base station control apparatus is further configured to verify the signature of and decrypt the measurement report message.

21. The base station of claim 19 wherein the base station control apparatus is further configured to generate a context data message containing the context identification information; and to cause the base station to transmit the context data message to the selected target base station.

22. The base station of claim 21 where the base station control apparatus is further configured to sign the context data message with a UE-specific security key shared among base stations listed in the user equipment secret key cryptography.

23. The base station of claim 21 where the base station control apparatus is further configured to encrypt content contained in the context data message with a UE-specific security key shared among base stations listed in the user equipment secret key cryptography.

24. The base station of claim 23 where the context identification information is encrypted with the UE-specific security key.

25. The base station of claim 21 wherein the base station control apparatus is further configured to access a context confirmation message received from the selected target base station, the context confirmation message containing content signed with a security key shared only by the user equipment and the target base station.

26. The base station of claim 25 wherein the content signed with a security key shared only by the user equipment and the target base station comprises at least new context identification information identifying the context between the user equipment and the target base station.

27. The base station of claim 26 wherein the base station is further configured to send a handover command message to the user equipment, the handover command message containing at least an identification of the target base station selected to receive the handoff and the content received from the selected target base station, the content signed with a security key shared only by the user equipment and the target base station.

28. The base station of claim 27 where the base station control apparatus is further configured to access a handover completed message received by the transceiver.

29. A base station comprising:
a transceiver configured for bidirectional communication in a wireless telecommunications network; and
base station control apparatus coupled to the transceiver, the base station control apparatus configured to operate the base station as a target base station during handoff operations involving user equipment; to identify context identification information in handoff-related messages received from source base stations; to determine whether the base station has received context for a handoff using the context identification information; and if context for a handoff has not been received, to use the context identification information to request the context from a source base station.

30. The base station of claim 29 wherein the base station control apparatus is further configured to generate a context confirmation message, the context confirmation message comprising context identification information identifying a new context for the base station, the context identification information to be used in subsequent handoffs; and to cause the base station to transmit the context confirmation message to the source base station.

31. The base station of claim 30 wherein the base station is further configured to sign context identification information contained in the context confirmation message with a security key shared only by the base station and the user equipment.

32. The base station of claim 30 wherein the base station control apparatus is further configured to access a handover confirmation message received by the base station from the user equipment, the handover confirmation message comprising content signed with a security key shared only by the user equipment and the wireless communications network.

33. The base station of claim 32 wherein the base station control apparatus is further configured to cause the base station to transmit a path switch message to the wireless communications network, the patch switch message containing the content from the handover confirmation message signed with a security key shared only by the wireless communications network and the user equipment.

34. The base station of claim 33 wherein when the base station control apparatus is further configured to generate a handover completed message; and to cause the base station transmit the handover completed message to the superseded source base station.

35. A method comprising:
at user equipment in a wireless communication system:
predicting a candidate base station to receive a handoff from a source base station currently handling communications for the user equipment; and
pre-calculating at least one security key to be used for communicating with the candidate base station if the candidate base station receives the handoff.

36. The method of claim 35 further comprising:
at user equipment in the wireless communication system:
generating a measurement report message containing a measurement list, a Nonce_{UE}, and the identity of the candidate base station;
signing and encrypting the measurement report message with a security key shared only by the user equipment and the source base station; and
transmitting the measurement report message to the source base station.

37. The method of claim 36 further comprising:
at a source base station in the wireless communication system:
receiving the measurement report message;
selecting, in dependence on data contained in the measurement report message, the target base station to receive the handoff;
generating a context data message containing at least context identification information for the handoff;
encrypting at least the context identification information portion of the context data message with a user-equipment-specific security key shared by the source and target base station; and
transmitting the context data message to the target base station.

38. The method of claim 37 further comprising:
at the target base station in the wireless communication system:
receiving the context data message; and
decrypting the context identification information portion of the context data message.

39. The method of claim 38 further comprising:
at the target base station in the wireless communication system:
in the case of a reactive handoff, using the context identification information decrypted from the context data message to request context information for the handoff from the source base station.

40. The method of claim 37 further comprising:
at the user equipment:
receiving a handover command message containing at least context identification information identifying a new context between the user equipment and the target base station;
generating a handover confirmation message containing at least a sequence number identifying the handover confirmation message;
signing at least a portion of the handover confirmation message with a security key shared only by the wireless communications network and the user equipment; and
transmitting the handover confirmation message to the target base station.

41. The method of claim 40 further comprising:
at the target base station:
receiving the handover confirmation message;
generating a path switch message containing content received in the handover confirmation message from the user equipment, the content signed with a security key shared only by the wireless communications network and the user equipment; and
transmitting the path switch message to the wireless communications network.

42. A computer program product comprising a computer readable memory medium storing a computer program configured to be executed by digital processing apparatus of user equipment operative in a wireless telecommunications network, wherein when the computer program is executed operations are performed, the operations comprising: predicting a candidate base station to receive a handoff from a source base station currently handling communications for the user equipment; and pre-calculating at least one security key to be used for communicating with the candidate base station if the candidate base station receives the handoff.

43. An integrated circuit for use in a base station operative in a wireless communications network, the integrated circuit comprising circuitry configured to operate the base station as a source base station during handoff-related operations; to access a measurement report message received by the base station from user equipment; to select, in dependence on data contained in the measurement report message, a target base station to receive a handoff involving the user equipment; to generate a context data message containing at least context identification information for the handoff; to encrypt at least the context identification information portion of the context data message with a user-equipment-specific security key shared by the source and target base station; and to cause the base station to transmit the context data message to the target base station.
